(19) United States
(12) Patent Application Publication
(10) Pub. No.: US 2021/0031558 A1
(43) Pub. Date: Feb. 4, 2021

(54) PAINT CAN AND PAINT CAN MIXING SYSTEM

(71) Applicants: John E Mazur, Hainesport, NJ (US); Deborah L Mazur, Hainesport, NJ (US)

(72) Inventors: John E Mazur, Hainesport, NJ (US); Deborah L Mazur, Hainesport, NJ (US)

(21) Appl. No.: 16/525,966

(22) Filed: Jul. 30, 2019

(51) Int. Cl. B44D 3/08; B01F 13/00; B01F 15/00; B01F 7/16; B44D 3/12

(52) U.S. Cl. CPC B44D 3/08; B01F 13/002; B01F 15/00688; B01F 2215/005; B44D 3/12; B01F 15/00506; B01F 7/1695

(57) ABSTRACT

A paint can and paint can mixing system effectively and cleanly mixes and stirs paint within the can by using a bottom mounted crank connected through the bottom of the can by a shaft which rotates a stirring member within the can. The crank is conveniently configured to be stored beneath the bottom of the paint can and to be pivoted downward when mixing of the paint within the can is desired. A shallow sidewall circumscribes the bottom of the paint can. The sidewall encloses a space in which the crank is located in its stored position. This allows easy and space saving stacking of the paint cans.

### BACKGROUND OF THE INVENTION

The paint in paint cans is routinely mixed in one of three ways: by paint can shaking machines; by paint can stirring systems located on the top of paint cans, as exemplified in U.S. Pat. Nos. 3,134,577, 5,094,543, 6,511,218; and by removing the lids of the paint cans and using wood or plastic stirrers to manually stir the paint. All three paint mixing means have distinct disadvantages.

Paint can shaking machines are commonly located only at commercial paint store and like facilities. They are expensive and generally not owned by consumers. Top mounted paint can stirring systems are not readily available, since they have a number of individual parts which makes them impractical and expensive to manufacture. Their use also results in dripping paint both on the stirring system and on the paint cans on which they are mounted. Manually stirring is also a potentially messy process, often resulting in paint dripping on the top and sides of the paint can.

Thus, there is currently no paint can mixing system which is efficient and effective in mixing paint within a paint can, simply and without mess and loss of paint.

### SUMMARY OF THE INVENTION

It is thus the object of the present invention to provide a paint can and paint can mixing system which overcomes the limitations and disadvantages of existing means of mixing or stirring paint in a paint can.

This and other objects are accomplished by the present invention, a paint can and paint can mixing system Which effectively and cleanly mixes and stirs paint within the can by using a bottom mounted crank connected through the bottom of the can by a shaft which rotates a stirring member within the can. The crank is conveniently configured to be stored beneath the bottom of the paint can and to be pivoted downward when mixing of the paint within the can is desired. A shallow sidewall circumscribes the bottom of the paint can. The sidewall encloses a space in which the crank is located in its stored position. This allows easy and space saving stacking of the paint cans.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a cross-sectional view of the paint can mixing system of the present invention.

FIG. 2 is a bottom perspective, partial cross-sectional view of the paint can and paint can mixing system of the present invention with its crank in the storage position.

FIG. 3 is a bottom perspective, partial cross-sectional view of the paint can and paint can mixing system of the present invention with the crank in its operating position.

FIG. 4 is a perspective, partial cross-sectional view of the paint can and paint can mixing system of the present invention in its operating position.

FIG. 5 is a perspective, partial cross-sectional view of the paint can and paint can mixing system of the present invention illustrating the paint stirring operation.

FIG. 6 is a sectional view of paint cans of the present invention stacked one on another.

### DETAILED DESCRIPTION OF THE INVENTION

Paint can mixing system 1 comprises paint can or paint can container 2 for housing paint 4. Paint can 2 has top section 6 on which top paint can lid 8 is placed and bottom section 10 on which paint can bottom or paint can container bottom 12 is permanently affixed. Paint can bottom 12 has center opening 14 extending therethrough.

Shallow side wall 16 extends down from and circumscribes paint can bottom 12. Sidewall 16 has bottom edge 17. Space 18 is formed between paint can bottom 12 and bottom edge 17 of sidewall 16.

Paint stirrer member 20 with outwardly extending fins 22, is located within paint can 2. The FIGs. disclose an impellor type paint stirrer member; however, the invention is not to be considered restricted to this type of paint stirrer. It is anticipated that any common liquid stirrer, e.g. propeller shaped, spiral shaped, etc., could be utilized.

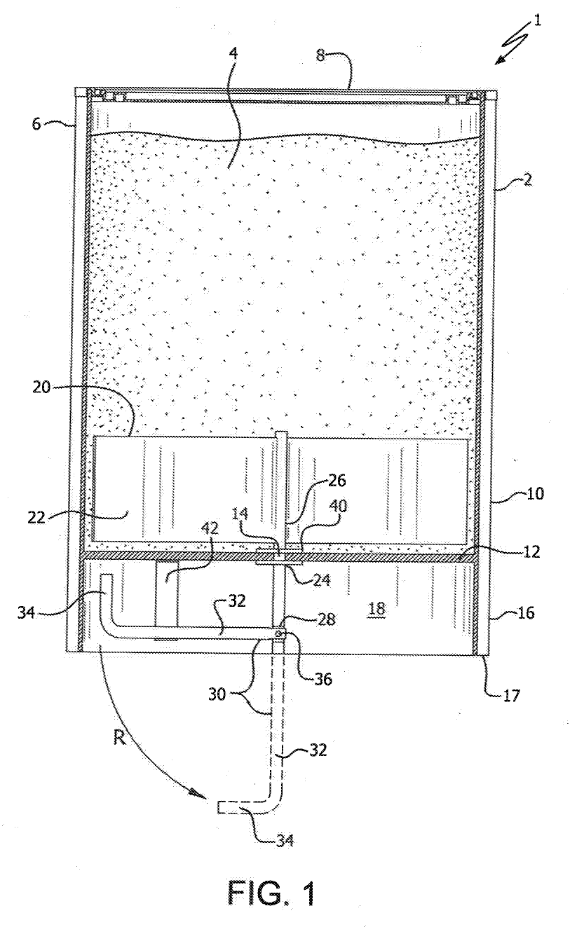

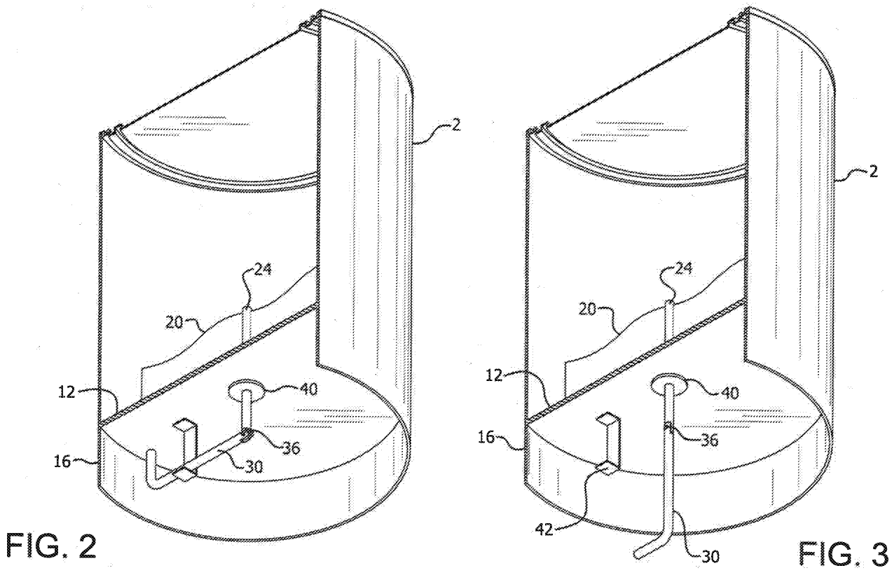

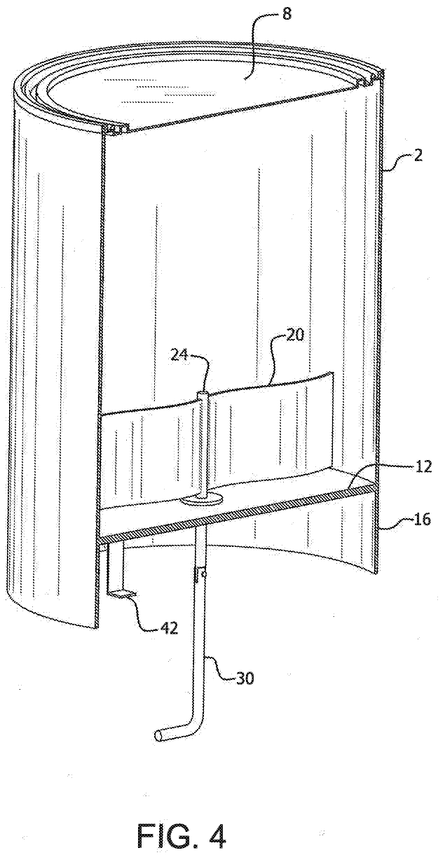

Shaft 24 has first, upper end 26 connected to stirrer member 20. Shaft 24 extends from its first end 26 through opening 14 and out paint can bottom 12, such that second lower end 28 of the shaft is outside the paint can bottom. Crank means 30, which may take the form of a lever arm 32 with crank handle 34, or other shaft turning device, is connected to second end 28 of shaft 24. Hinge 36 is positioned between lever arm 32 and shaft 24 to allow crank 30 to be rotatable from a first storage position in which the crank is substantially parallel to paint can bottom 12 and located within space 18 (see FIGS. 1, 2, and 6), to a second cranking position in which the crank extends down from the paint can bottom (see FIGS. 1, 3-5).

Flexible clip 42, secured to paint can bottom 12, retains crank 30 when it is in its first storage position 37, substantially parallel to the paint can bottom and within space 18.

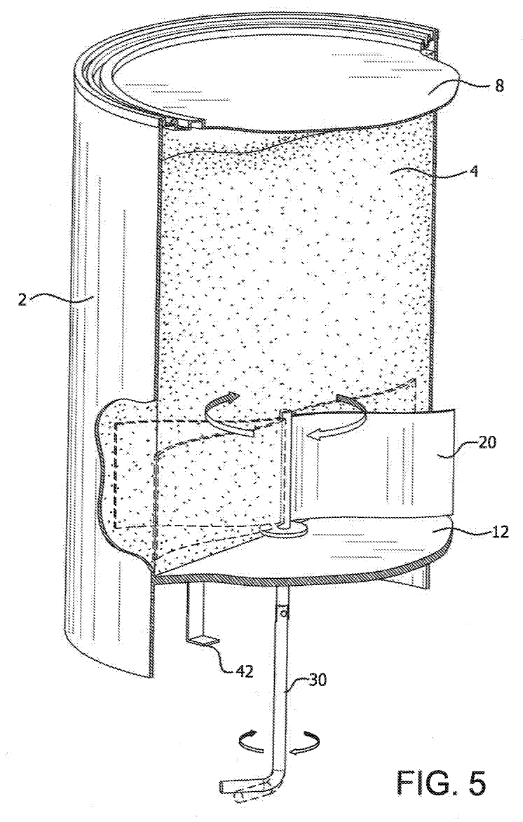

In use, crank 30 is removed from clip 42 and rotated R from its first storage position down to its second cranking position (see FIG. 1). Crank 30 is then turned, via handle 34, which in turn rotates shaft 24 and stirrer member 20, thus mixing paint 4 within paint can 2 (see FIG. 5). Once paint 4 is thoroughly mixed, paint can lid 8 is removed from top section 6 and painting can begin. After painting is completed, lid 8 is replaced and again secured onto top section 6 of paint can 2. Crank 30 is rotated up to its first storage position and again secured by clip 42 within space 18.

Paint can mixing system 1 of the present invention accomplishes a number of significant advantages over all prior and existing paint can mixing means. Other than when a paint can shaker machine (usually found only in paint stores) used, all paint which is mixed within a paint can is currently mixed or stirred from the top of the can. The top lid must first be removed, which most often results in dripped paint. The open can is stirred, usually resulting in additional paint dripping on and around the can and in the surrounding area. After the lid is returned to the top of the paint can the paint which has dripped on top of the can will ultimately dry, making it difficult to subsequently remove the lid when painting from the can is again desired.

The current invention successfully addresses these problems. Since all stirring is from the bottom of the paint can, the top lid need not be removed until the actual painting process is to begin. Dripping paint from the pre-painting, stirring process is successfully eliminated. This results in the effective and clean stirring of paint within the paint can.

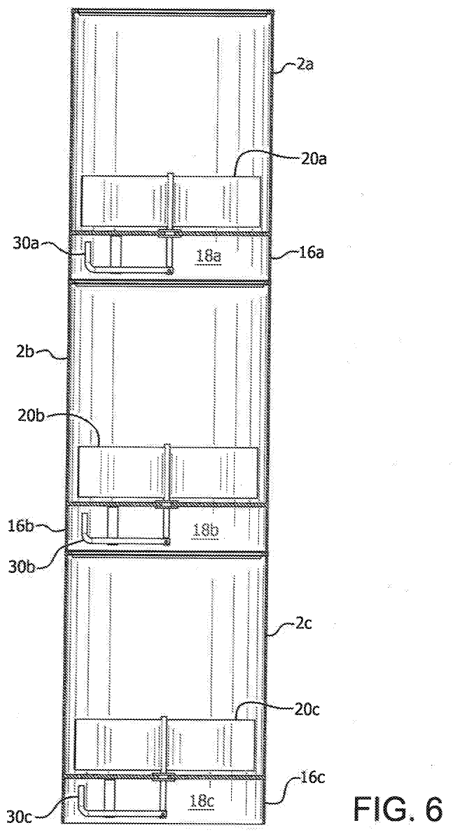

In addition, none of the paint cans having can top mounted stirring systems can be stacked. These paint cans can only be stored side-by-side. In most cases, this results in an inefficient use of space. Sidewall 16 extending down from paint can 2 of the present invention, not only provides a space in which crank 30 is located when the can is being stored and is not in use, but it also allows paint cans to be stacked one on top of another. As seen in FIG. 6, paint cans 2a, 2b, and 2c, which contain stirrer members 20a, 20b, and 20c, allow cranks 30a, 30b, and 30c to be stored in spaces 18a, 18b, and 18c. Sidewalls 16a, 16b, and 16c permit easy and safe stacking of the paint cans.

Certain novel features and components of this invention are disclosed in detail in order to make the invention clear in at least one form thereof However, it is to be clearly understood that the invention as disclosed is not necessarily limited to the exact form and details as disclosed, since it is apparent that various modifications and changes may be made without departing from the spirit of the invention.

1. A paint can comprising:
a paint can container for holding paint, said container having a top and a bottom;
a paint can container lid positioned on and removable from the top of the paint can container;
a paint can container bottom permanently affixed to the bottom of the paint can container, said paint can container bottom having an opening therethrough;
a stirrer member having outwardly extending fins, said stirrer being located within the paint can container;
a shaft having first and second ends, the first end of the shaft connected to the stirrer member, the shaft extending from the stirrer member, and out through the opening in the paint can container bottom, such that the second end of the shaft is outside the paint can container bottom; and
crank means rotatably connected to the second end of the shaft for rotating the stirrer, wherein when the crank means is rotated, the stirrer member is rotated and the paint within the paint can container is mixed.

2. The paint can as in claim 1 further comprising gasket means circumscribing the shaft for providing a seal around the opening of the paint can container bottom.

3. The paint can as in claim 1 Wherein the paint can container body comprises a shallow sidewall with a bottom edge, the shallow sidewall extending down from and circumscribing the paint can container bottom such that a space is formed between the paint can container bottom and the bottom edge of the sidewall.

4. The paint can as in claim 1 wherein the crank means is connected to the shaft by a hinge, the crank means being pivotable from a first storage position substantially parallel to the paint can container bottom, to a second cranking position in which the crank means extends down from the paint can container bottom, wherein in the second cranking position, the crank means is configured to rotate the stirrer member and paint within the paint can container.

5. The paint can as in claim 2 wherein the paint can container body comprises a shallow sidewall with a bottom edge, the shallow sidewall extending down from and circumscribing the paint can container bottom such that a space is formed between the paint can container bottom and the bottom edge of the sidewall, and wherein the crank means being connected to the shaft by a hinge, the crank means being rotatable from a first storage position substantially parallel to the paint can container bottom to a second cranking position.

6. The paint can as in claim 3 wherein the crank means is rotatable from a first storage position substantially parallel to the paint can container bottom to a second cranking position extending from the paint can container bottom to allow the crank means to rotate the stirrer and the paint within the paint can container, the crank means being located completely within the space when it is in the first storage position.

7. A paint can mixing system comprising:
a paint can for holding paint, said can having a top and a bottom;
a paint can lid positioned on and removable from the top of the paint can, said paint can bottom being permanently affixed to the bottom of the paint can, said paint can bottom having an opening therethrough;
a stirrer member having outwardly extending fins, said stirrer member being located within the paint can;
a shaft having first and second ends, the first end of the shaft being connected to the stirrer member, the shaft extending from the stirrer member and out through the opening in the paint can bottom, such that the second end of the shaft is outside the paint can bottom; and
crank means rotatably connected to the second end of the shaft for rotating the stirrer member, wherein when the crank means is rotated, the stirrer member is rotated and paint within the paint can is mixed.

8. The paint can mixing system as in claim 7 further comprising gasket means circumscribing the shaft for providing a seal around the opening of the paint can bottom.

9. The paint can mixing system as in claim 7 wherein the paint can comprises a shallow sidewall with a bottom edge, the shallow sidewall extending down from and circumscribing the paint can bottom such that a space is formed between the paint can bottom and the bottom edge of the sidewall.

10. The paint can mixing system as in claim 7 wherein the crank means is connected. to the shaft by a hinge, the crank means being pivotable from a first storage position substantially parallel to the paint can bottom, to a second cranking position in which the crank means extends down from the paint can bottom, wherein in the second cranking position, the crank means is configured to rotate the stirrer member and paint within the paint can.

11. The paint can mixing system as in claim 8 wherein the paint can comprises a shallow sidewall with a bottom edge, the shallow sidewall extending down from and circumscribing the paint can bottom such that a space is formed between the paint can bottom and the bottom edge of the sidewall, and wherein the crank means being connected to the shaft by a hinge, the crank means being rotatable from a first storage position substantially parallel to the paint can bottom to a second cranking position.

12. The paint can mixing system as in claim 9 wherein the crank means is rotatable from a first storage position substantially parallel to the paint can bottom to a second cranking position extending from the paint can bottom to allow the crank means to rotate the stirrer and the paint within the paint can, the crank means being located completely within the space when it is in the first storage position.
